(19) United States
(12) Patent Application Publication
(10) Pub. No.: US 2013/0083385 A1
(43) Pub. Date: Apr. 4, 2013

(54) OPTICAL ELEMENT, DISPLAY APPARATUS, ELECTRONIC DEVICE, AND WIRING SUBSTRATE

(71) Applicants: Miki Tsuchiya, Tokyo (JP); Yasuhiro Watanabe, Tokyo (JP)

(72) Inventors: Miki Tsuchiya, Tokyo (JP); Yasuhiro Watanabe, Tokyo (JP)

(73) Assignee: SONY CORPORATION, Tokyo (JP)

(21) Appl. No.: 13/614,627

(22) Filed: Sep. 13, 2012

(30) Foreign Application Priority Data
Sep. 29, 2011 (JP) 2011-215115

(51) Int. Cl. G02B 26/02

(52) U.S. Cl. 359/228

(57) ABSTRACT

An optical element includes: first and second substrates arranged opposite to each other; a plurality of partition walls which rise from an inner surface of the first substrate, which faces the second substrate, and which also adjoin to one another in a first direction, and extend in a second direction differing from the first direction; and first and second through-holes which are formed in a region held between the adjoining paired partition walls on the first substrate. The element further includes: first and second electrodes which are formed on the surface of the partition walls in such a way that they partly face each other; an insulating film covering the first and second electrodes; a third electrode formed on an inner surface of second substrate, which faces the first substrate; and polar and apolar liquids, both having mutually different refractive indices, which are enclosed between the first and third electrodes.

### CROSS REFERENCES TO RELATED APPLICATIONS

The present application claims priority to Japanese Priority Patent Application JP 2011-215115 filed in the Japan Patent Office on Sep. 29, 2011, the entire content of which is hereby incorporated by reference.

### BACKGROUND

The present disclosure relates to an optical element that utilizes the phenomenon called electrowetting, a display apparatus and an electronic device provided with it, and a wiring substrate to be used for them.

There has been developed a liquid optical element which exhibits its optical action through the phenomenon called electrowetting (or electrocapillary action). This phenomenon refers to the change in surface state of a liquid which occurs upon application of a voltage across an electrode and an electrically conductive liquid (or polar liquid) as the result of the interfacial energy changing between the electrode surface and the liquid.

The present applicant had previously proposed a stereoscopic image display apparatus which is provided with a liquid optical element, which utilizes the phenomenon called electrowetting, as the lenticular lens. (See Japanese Patent Laid-open Nos. 2009-247480 and 2011-95369, for example.)

### SUMMARY

The liquid optical element that utilizes the phenomenon called electrowetting, which is to be used as the lenticular lens, suffers the disadvantage of requiring a large number of electrodes and leads for the electrodes. For high-definition stereoscopic image display, it needs a large number of leads with secure connection to electrodes in a limited region.

Recent trends in the liquid optical element are toward the replacement of glass substrates with plastic ones for weight saving etc. Unfortunately, plastic substrates are liable to thermal deterioration and hence unsuitable for metal wiring by photolithography. Moreover, they present difficulties in the accurate alignment of metal wirings formed by means of a metal mask on account of their much larger coefficient of thermal expansion as compared with glass.

The present disclosure has been made in order to solve the problems described above, and aims to provide an optical element, display apparatus, and electronic device (which are capable of accurate action despite their compact structure) and a wiring substrate for them which has accurately arranged leads in its compact structure.

A first mode of the present disclosure is directed to an optical element which is composed of the following components:

(A1) a first substrate and a second substrate which are arranged opposite to each other;
(A2) a plurality of partition walls which rise from the inner surface of the first substrate, which faces the second substrate, and which also adjoin to one another in a first direction and extend in a second direction differing from the first direction;
(A3) a first through-hole and a second through-hole which are formed in a region held between the adjoining paired partition walls on the first substrate;
(A4) a first electrode and a second electrode which are formed on the surface of the partition walls in such a way that they partly face each other;
(A5) insulating film covering the first and second electrodes, and a third electrode which is formed on the inner surface of second substrate facing the first substrate; and
(A6) a polar liquid and an apolar liquid, both having mutually different refractive indices, which are enclosed between the first substrate and the third electrode; with the first electrode being connected through the first through-hole to a first lead wire formed on the outer surface of the first substrate which is opposite to the inner surface, and with the second electrode being connected through the second through-hole to a second lead wire formed on the outer surface of the first substrate.

A second mode of the present disclosure is directed to a display apparatus which is composed of a display means and the optical element mentioned above.

A third mode of the present disclosure is directed to electronic device which has the display apparatus mentioned above. Incidentally, the display means is one which has a plurality of pixels and is capable of generating two-dimensional display images in response to video signals.

According to the present disclosure, the optical element, the display apparatus and the electronic device are constructed such that the first electrode and the second electrode, which are formed on the inner surface of the first substrate, are connected respectively to the first and second lead wires, which are formed on the outer surface opposite to the inner surface, through the first and second through-holes. This structure offers the advantage of allowing the first and second lead wires to have a sufficient width and a sufficient arrangement pitch without requiring for the optical element as a whole to increase in the area it occupies. Moreover, the fact that the first and second through-holes are positioned in the region held between the adjacent paired partition walls eliminates short-circuits (due to manufacturing errors) between the first and second electrodes which adjoin each other with the partition wall held between them. This facilitates the easier and secure connection of the first and second lead wires with the first and second electrodes.

A fourth mode of the present disclosure is directed to a wiring substrate which is composed of the following components:

(B1) a plastic resin substrate;
(B2) a plurality of partition walls rising on one surface of the plastic resin substrate;
(B3) a through-hole formed in the plastic resin substrate in the region held between a pair of the partition walls facing each other;
(B4) a pair of electrically conductive films formed on both surfaces of the plastic resin substrate; and
(B5) a connecting part for the connection of the paired electrically conductive films through the through-hole.

The wiring substrate according to the present disclosure is characterized in that a pair of electrically conductive films formed on both surfaces of the plastic resin substrate are connected to each other through the through-hole positioned in the region held between the paired partition walls. This structure permits the paired electrically conductive films to have adequate dimensions and sufficient intervals without the necessity of increasing the area which the wiring substrate as a whole occupies. Moreover, the fact that the through-holes are positioned in the region held between the adjacent paired partition walls eliminates short-circuits due to such as manufacturing errors between the electrically conductive films which adjoin each other with the partition wall interposed between them.

The present disclosure discloses a wiring substrate which has mutually insulated and accurately arranged lead wires in its compact structure. In addition, the present disclosure discloses an optical element, display apparatus, and electronic device which are provided with the wiring substrate so that they produce accurate stereoscopic images in response to video signals.

Additional features and advantages are described herein, and will be apparent from the following Detailed Description and the figures.

### BRIEF DESCRIPTION OF THE FIGURES

FIG. 1 is a schematic diagram depicting the structure of the stereoscopic display apparatus pertaining to one embodiment of the present disclosure;

FIG. 2 is a perspective view depicting the major parts constituting the wave surface conversion deflector shown in FIG. 1;

FIG. 3 is a plan view depicting the major parts constituting the wave surface conversion deflector shown in FIG. 1;

FIG. 4 is a sectional view taken along the line IV-IV in FIG. 3 depicting the major parts constituting the wave surface conversion deflector;

FIG. 5 is a sectional view taken along the line IV-IV in FIG. 3 depicting the major parts constituting the wave surface conversion deflector;

FIGS. 6A and 6B are enlarged sectional views depicting the major parts constituting the wave surface conversion deflector shown in FIG. 1;

FIGS. 7A to 7C are conceptual diagrams illustrating the action of the liquid optical element shown in FIG. 3;

FIGS. 8A and 8B are the other conceptual diagrams illustrating the action of the liquid optical element shown in FIG. 3;

FIG. 9 is a perspective view illustrating one step of the process for producing the wave surface conversion deflector shown in FIG. 1;

FIG. 10 is a schematic sectional view illustrating one step that follows the step shown in FIG. 9;

FIG. 11 is a schematic sectional view illustrating one step that follows the step shown in FIG. 10;

FIG. 12 is a perspective view depicting the construction of the television set as the electronic device provided with the display apparatus according to the present disclosure; and

FIG. 13 is a sectional view depicting another example of the wave surface conversion deflector shown in FIG. 1.

### DETAILED DESCRIPTION

A detailed description is given below, with reference to the accompanying drawings, of the stereoscopic display apparatus and the application example according to an embodiment of the present disclosure. The description will be made in the following order:

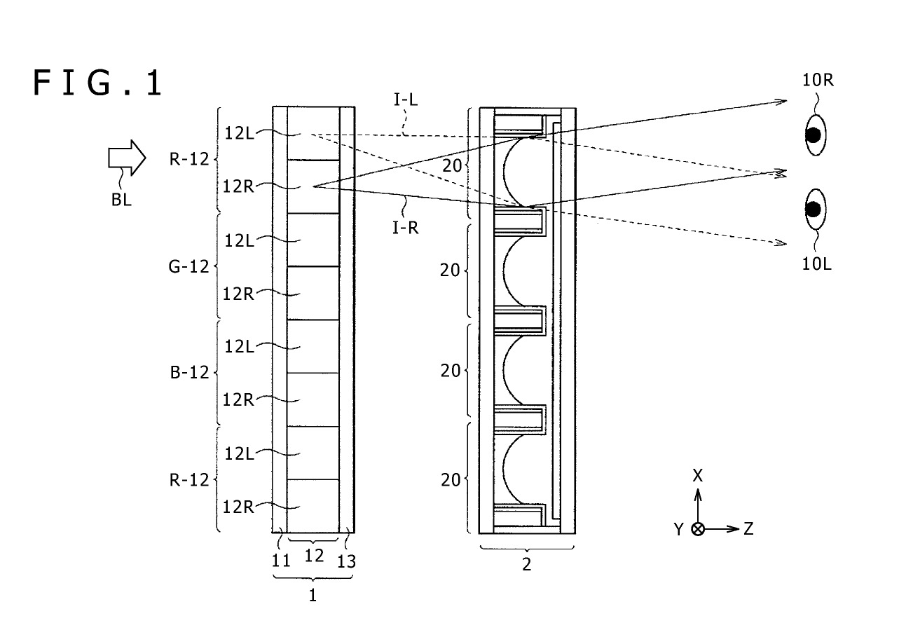

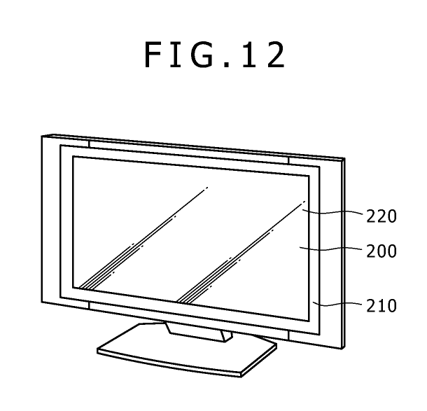

1. Embodiment (shown in FIGS. 1 to 11): stereoscopic display apparatus; and
2. Application example (shown in FIG. 12): electronic device.

### Embodiment

### Construction of the Stereoscopic Display Apparatus

The following is a description referring to FIG. 1 of the stereoscopic display apparatus which is provided with the liquid optical element array according to the embodiment of the present disclosure. FIG. 1 is a schematic diagram (viewed in the direction of horizontal plane) showing the construction of the stereoscopic display apparatus according to the embodiment of the present disclosure.

As shown in FIG. 1, the stereoscopic display apparatus includes the display unit 1 having a plurality of pixels 12 and the wave surface conversion deflector 2 which is the array of liquid optical elements. The display unit 1 and the wave surface conversion deflector 2 are arranged from a light source (not shown) side in this order. Here, the Z-axis represents the direction in which the light source emits light, the X-axis represents the horizontal direction, and the Y-axis represents the vertical direction.

The display unit 1 generates two-dimensional display images in response to video signals. It may be a color liquid-crystal display, for example, which emits light of display images by being illuminated by a backlight BL. The display unit 1 has a laminated structure including a glass substrate 11, a plurality of pixels 12 (12L, 12R), and a glass substrate 13, which are arranged in this order from the light source side. The pixels 12 individually include a pixel electrode and a liquid-crystal layer. Both the glass substrate 11 and the glass substrate 13 are transparent, and either of them is provided with the color filter taking on red (R), green (G), and blue (B) colors. Therefore, each pixel 12 is divided into the pixel R-12 for red color, the pixel G-12 for green color, and the pixel B-12 for blue color. The display unit 1 is constructed such that the pixels R-12, G-12, and B-12 are arranged sequentially and repeatedly in the direction of X-axis, and the pixels 12 of the same color are arranged in the direction of Y-axis. Moreover, the pixels 12 are divided into ones which emit light for the display image to be viewed by the left eye and ones which emit light for the display image to be viewed by the right eye. They are arranged alternately in the direction of X-axis. In FIG. 1, the pixels 12 are divided into the pixels 12L for the left image and the pixels 12R for the right image, respectively.

The wave surface conversion deflector 2 is an array of a plurality of the liquid optical element 20 arranged in the direction of X-axis, with each liquid optical element 20 corresponding to a pair of pixels 12L and 12R juxtaposed in the direction of X-axis. The wave surface conversion deflector 2 performs wave surface conversion and deflection on the light of display images which is emitted from the display unit 1. To be concrete, the wave surface conversion deflector 2 is designed such that each of the liquid optical element 20 corresponding to each pair of the pixels 12 functions as a cylindrical lens. In other words, the wave surface conversion deflector 2 as a whole functions as a lenticular lens. Thus, the light of display image emitted from the individual pixels 12L and 12R has its wave surface converted into the one which has a prescribed curvature. This action is applied to a group of pixels 12 (as a unit) arranged in the vertical direction or the direction of Y-axis. The wave surface conversion deflector 2 is also able to perform deflection on the light of display images all at once in the horizontal plane (or in the XZ-plane, according to need.

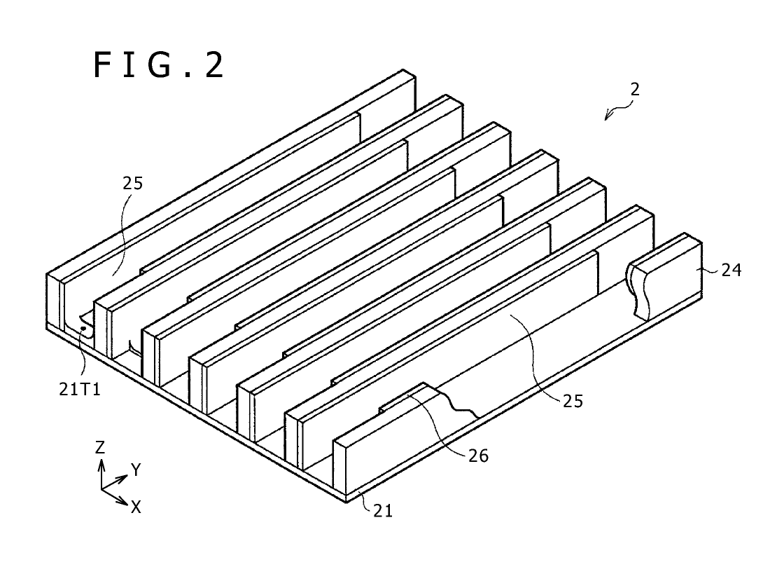

The structure of the wave surface conversion deflector 2 will be specifically described below with reference to FIGS. 2 to 6B.

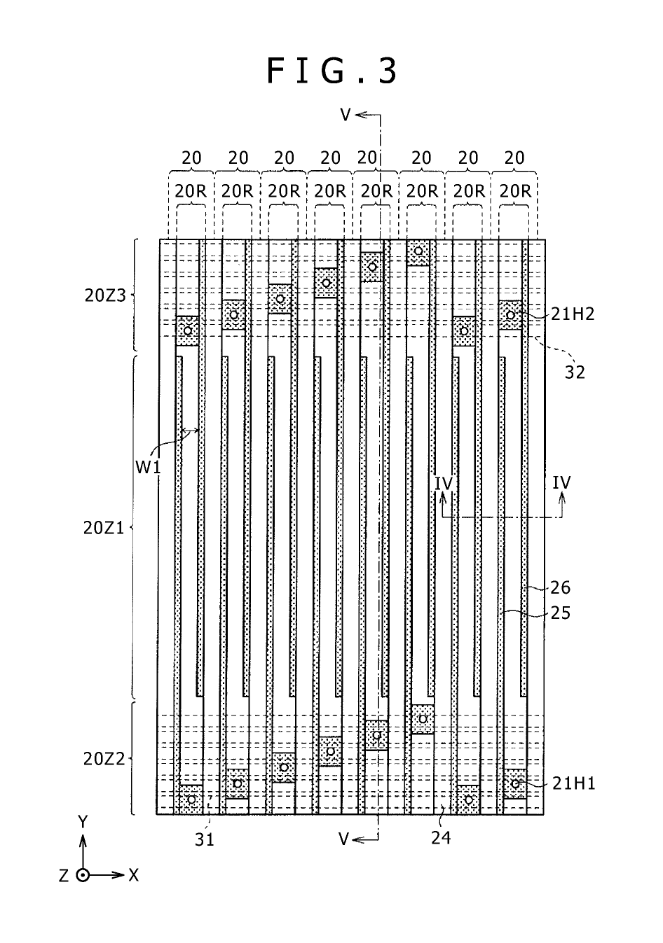

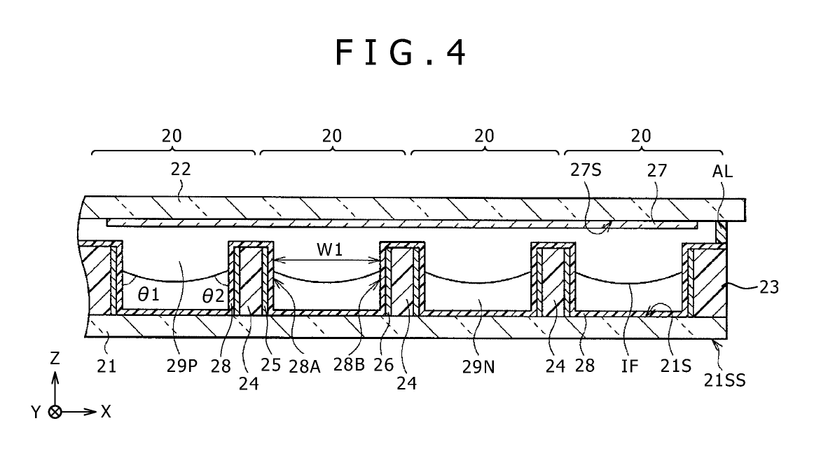

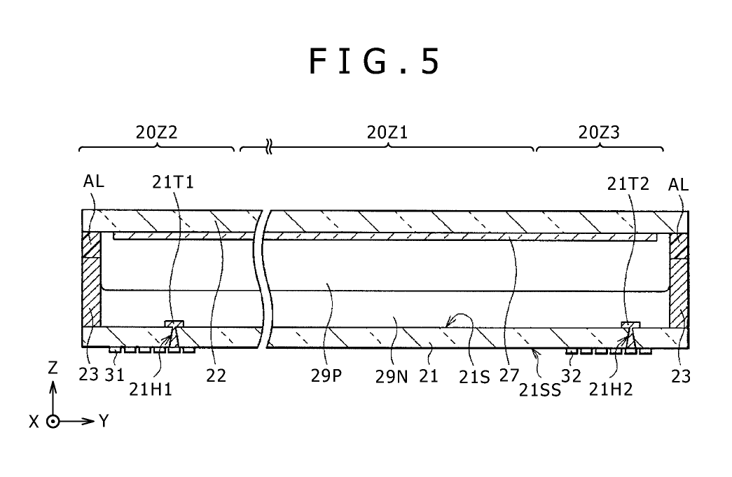

FIG. 2 is a perspective view depicting the major parts of the wave surface conversion deflector 2. FIG. 3 is a plan view (perpendicular to the line of sight of the viewer) showing the X-Y plane of the wave surface conversion deflector 2. FIG. 4 is a sectional view taken along the line IV-IV in the direction of arrows shown in FIG. 3. FIG. 5 is a sectional view taken along the line V-V in the direction of arrows shown in FIG. 3.

The wave surface conversion deflector 2 includes a pair of flat substrates 21 and 22 which are arranged opposite to each other, side walls 23, and partition walls 24 arranged between them. The flat substrate 22 is supported over the flat substrate 21 by the side wall 23 projecting upward from an inner surface 21S of the flat substrate 21, and the flat substrate 22 is bonded to the side wall 23 by the adhesion layer AL. In addition, the wave surface conversion deflector 2 has a plurality of the liquid optical element 20 which are arranged in the direction of X-axis. Each of the liquid optical element 20 is separated by a plurality of the partition wall 24 extending in the direction of Y-axis. This structure constitutes the array of the liquid optical elements 20. Each of the liquid optical element 20 holds two kinds of liquids differing in refractive index, one being the polar liquid 29P and the other being the apolar liquid 29N. These polar and apolar liquids perform deflection and refraction (or the wave surface conversion action and the deflection action) on the incident light. Incidentally, FIGS. 2 and 3 do not show the adhesive layer AL, the side wall 23, the flat substrate 22, the polar liquid 29P, the apolar liquid 29N, an insulating film 28 (mentioned later), and a third electrode 27 (mentioned later).

The flat substrates 21 and 22 are made of a transparent insulating material which permeates visible lights, such as glass and clear plastics. The flat substrate 21 has first and second connecting parts 21T1 and 21T2 and first and second lead wires 31 and 32 which are formed respectively on the inner surface 21S and an outer surface 21SS of the flat substrate 21 to form a wiring substrate. The flat substrates 21 and 22 have a thickness of hundreds to thousands of micrometers. On the inner surface 21S of the flat substrate 21 are a plurality of the partition walls 24 projecting therefrom which divide the space on the flat substrate 21 into a plurality of the liquid optical element 20. In other words, the liquid optical element 20 is formed in each of the element region 20R held between the adjacent partition walls 24. Since the partition walls 24 extend in the direction of Y-axis, the liquid optical elements 20 (or the element regions 20R) take on a flat square shape corresponding to a group of the display pixels 12 arranged in the direction of Y-axis. Each of the element region 20R holds the apolar liquid 29N, which is kept there by the partition wall 24 without moving (or flowing) into its adjacent element region 20R. The partition wall 24 should preferably be made of such materials as epoxy resin and acrylic resin which do not dissolve in the polar liquid 29P and the apolar liquid 29N. Incidentally, it is possible to integrally form the flat substrate 21 and the partition wall 24 from a clear plastic material. The partition walls 24 are arranged in the direction of X-axis at pitches of hundreds to thousands of micrometers. The partition walls 24 may have a height approximately equal to the distance between the adjacent partition walls 24.

Each of the partition wall 24 has first and second electrodes 25 and 26 on its surface in such a way that they extend in the direction of Y-axis (or in the direction in which the partition wall extends) and a portion of the first electrode 25 and a portion of the second electrode 26 face each other. There is a region between the electrodes 25 and 26 which overlap each other and face each other. This region is designated as the effective region 20Z1. It is in this region that the wave surface conversion and deflection are performed on the light of display image which is emitted from the display unit 1. The effective region 20Z1 is held (in the direction of Y-axis) between connecting regions 20Z2 and 20Z3 into which a portion of the electrode 25 and a portion of the electrode 26 extend respectively. In each of the connecting regions 20Z2 and 20Z3 are a plurality of the first lead wire 31 and a plurality of the second lead wire 32 which are formed on the outer surface 21SS opposite to the inner surface 21S of the flat substrate 21. (These lead wires are indicated by broken lines in FIG. 3.) The first and second lead wires 31 and 32 having a strip-like shape extend in the direction of X-axis which is perpendicular to Y-axis. That portion of the connecting region 20Z2 and that portion of the connecting region 20Z3, each of which is held between a pair of the partition walls 24, have the first and second through-holes 21H1 and 21H2 formed respectively therein, in such a way that they penetrate the flat substrate 21 in its thickness direction (or in the direction of Z-axis).

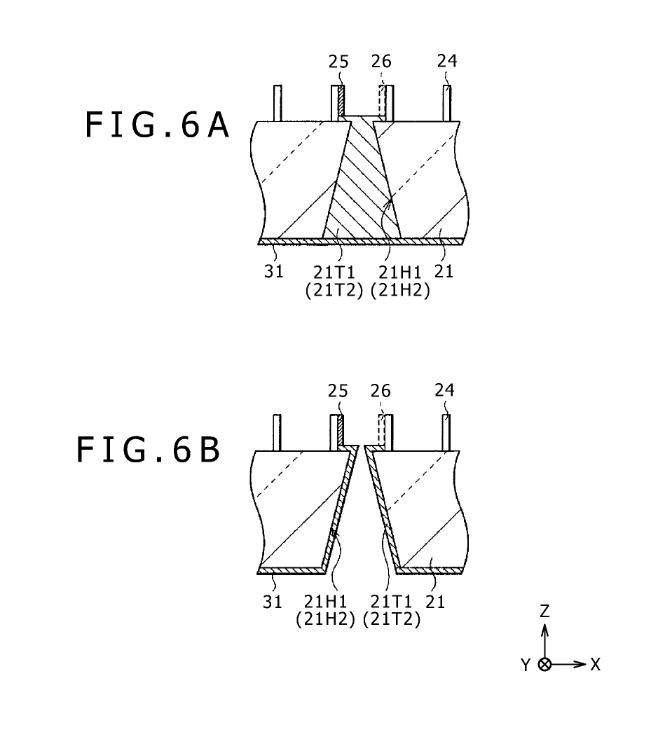

The first electrode 25 is connected to the first lead wire 31 through the first through-hole 21H1. Likewise, the second electrode 26 is connected to the second lead wire 32 through the second through-hole 21H2. In other words, each of the first electrode 25 has each of the first through-hole 21H1, and each of the second electrode 26 has each of the second through-hole 21H2. The first and second through-holes 21H1 and 21H2 are formed in such a way that they gradually increase in diameter in going from the inner surface 21S to the outer surface 21SS of the flat substrate 21 (or they have a cone-shaped form) as shown in FIGS. 6A and 6B. For example, the first and second through-holes 21H1 and 21H2 have a diameter of 100 μm at the outer surface 21SS and a diameter of 30 μm at the inner surface 21S, assuming that the flat substrate 21 has a thickness of 200 μm. Incidentally, FIGS. 6A and 6B are enlarged sectional views illustrating the structure of the first and second through-holes 21H1 and 21H2 and their surroundings.

Each of the first and second through-holes 21H1 and 21H2 has its inner space filled (as shown in FIG. 6A) or its inner surface coated (as shown in FIG. 6B), so that the coating or fill functions as the first or second connecting part 21T1 or 21T2. Incidentally, the first and second connecting parts 21T1 and 21T2 shown in FIG. 6A are referred to as those of filled via type, and the first and second connecting parts 21T1 and 21T2 shown in FIG. 6B are referred to as those of conformal via type. Thus the first connecting part 21T1 connects the first electrode 25 to the first lead wire 31, and the second connecting part 21T2 connects the second electrode 26 to the second lead wire 32. Here, the connection between the first electrode 25 and the first lead wire 31 repeats periodically (at intervals of six in FIG. 3), and the connection between the second electrode 26 and the second lead wire 32 repeats periodically (at intervals of six in FIG. 3). However, the periodicity is not restricted to the one as shown in FIG. 3, and can be set arbitrarily.

The first and second electrodes 25 and 26, the first and second lead wires 31 and 32, and the first and second connecting parts 21T1 and 21T2 are formed from any one of the following materials: transparent electrically conductive materials such as indium-tin oxide (ITO) and zinc oxide (ZnO), metallic materials such as copper (Cu), and other electrically conductive materials such as carbon (C) and electrically conductive polymers.

The first and second through-holes 21H1 and 21H2 are formed by, for example, laser beam processing by applying a laser beam or machine processing (microvia processing).

In the connecting regions 20Z2 and 20Z3, the first and second connecting parts 21T1 and 21T2 are connected respectively to the first and second electrodes 25 and 26 that cover the surface 21S of the flat substrate 21 and the partition wall 24. The first and second electrodes 25 and 26 are connected to the external power source through the first and second connecting parts 21T1 and 21T2 and the first and second lead wires 31 and 32, so that they are supplied with voltage. The voltage for the first and second electrodes 25 and 26 is properly established by the controller (not shown) attached to the outer surface 21SS of the flat substrate 21.

The first and second electrodes 25 and 26 are tightly covered with the insulating film 28. The insulating film 28 may be formed in such a way that not only does it cover the first and second electrodes 25 and 26 but it also entirely covers the partition wall 24 and the flat substrate 21. This insulating film 28 is formed from a material which not only excels in electrical insulation but also repels the polar liquid 29P (or has affinity with the apolar liquid 29N in the absence of electric field). It typically includes fluoroplastics, such as polyvinylidene fluoride (PVdF) and polytetrafluoroethylene (PTFE), and silicone. For enhanced electrical insulation between the first electrode 25 and the second electrode 26, an additional insulating film of spin-on-glass (SOG) may be interposed between the insulating film 28 and the first and second electrodes 25 and 26. Incidentally, the top of the partition wall 24 or the insulating film 28 covering the top of the partition wall 24 should preferably be slightly away from the flat substrate 22 and the third electrode 27.

The flat substrate 22 has the third electrode 27 formed on its inner surface 22S opposite to the flat substrate 21. The third electrode 27 is formed from a transparent electrically conductive material such as ITO and ZnO. It functions as the grounding electrode.

The paired flat substrates 21 and 22 and partition walls 24 constitute a completely closed space which is tightly filled with the apolar liquid 29N and the polar liquid 29P. The apolar and polar liquids 29N and 29P separately exist in the closed space without mixing together, and they form the interface IF. Being transparent, the apolar and polar liquids 29N and 29P refract the light passing through the interface IF according to their refractive indices and the incident angle of the light.

The apolar liquid 29N is a liquid which has very little polarity and exhibits electrically insulating properties. It typically includes hydrocarbon liquids, such as decane, dodecane, hexadecane, and undecane, and silicone oil. The apolar liquid 29N should preferably exist in an amount sufficient to cover the flat substrate 21 (or the insulating film 28 on it) when no voltage is applied across the first electrode 25 and the second electrode 26.

The polar liquid 29P is a liquid with polarity, which typically includes water and aqueous solutions in which such electrolytic substances as potassium chloride and sodium chloride are dissolved. With a voltage applied thereto, the polar liquid 29P changes more than the apolar liquid 29N in wettability for the opposing inner surfaces 28A and 28B in the element region 20R. (The wettability is represented in terms of a contact angle between the surface of the polar liquid 29P and the inner surfaces 28A and 28B.) The polar liquid 29P remains in contact with the third electrode 27 as the grounding electrode.

The partition walls 24 are arranged in the X-axis at intervals not greater than K⁻¹ which is the capillary length defined by the formula (I) below. Strictly speaking, the interval equals a distance W1 between the insulating film 28 covering the adjacent partition walls 24 in the X-axis direction, as shown in FIGS. 3 and 4. This condition is necessary for the apolar liquid 29N and the polar liquid 29P to stably stay at their initial positions (as shown in FIG. 4). The initial positions are maintained because the apolar liquid 29N and the polar liquid 29P come into contact with the insulating film 28 covering the partition walls, thereby creating the interfacial tension at the contact surface that acts on the apolar liquid 29N and the polar liquid 29P. Here, the capillary length K⁻¹ denotes the maximum length definable on the assumption that gravity does not affect at all the interfacial tension between the apolar liquid 29N and the polar liquid 29P.

K⁻¹={Δγ/(Δρ×g)}^{0.5} (1)

where,

K⁻¹: capillary length (mm)

Δγ: interfacial tension between polar liquid and apolar liquid (mN/m)

Δρ: difference in density between polar liquid and apolar liquid (g/cm³)

g: acceleration of gravity (m/s²)

Each of the liquid optical elements 20, with no voltage applied across the first and second electrodes 25 and 26 (or both the first and second electrodes 25 and 26 at a zero potential), permits the interface IF therein to curve convexedly from the polar liquid 29P toward the apolar liquid 29N, as shown in FIG. 4. The interface IF in this state has the curvature which remains constant in the Y-axis; therefore, each of the liquid optical element 20 functions as a single cylindrical lens. Also, the interface IF in this state (with no voltage applied across the first and second electrodes 25 and 26) takes on the maximum curvature. It is possible to adjust the contact angle θ1 (between the inner surface 28A and the apolar liquid 29N) and the contact angle θ2 (between the inner surface 28B and the apolar liquid 29N) by properly selecting the kind of the material for the insulating film 28. The liquid optical element 20 produces a negative refraction if the apolar liquid 29N has a larger refractive index than the polar liquid 29P. By contrast, the liquid optical element 20 produces a positive refraction if the apolar liquid 29N has a smaller refractive index than the polar liquid 29P. For example, the liquid optical element 20 produces a negative refraction if the apolar liquid 29N is a hydrocarbon or silicone oil and the polar liquid 29P is water or an aqueous solution of electrolyte.

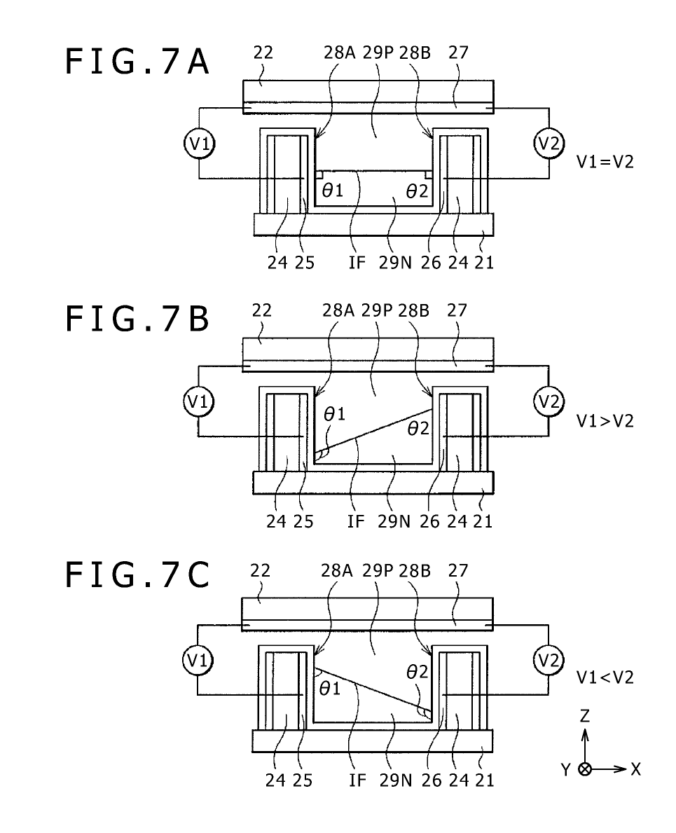

The interface IF decreases in curvature according as a voltage is applied across the first and second electrodes 25 and 26. When the voltage applied exceeds a certain level, the interface IF becomes flat as shown in FIGS. 7A to 7C. Incidentally, FIG. 7A shows an instance in which V1=V2, where V1 and V2 stand for the potential of the first and second electrodes 25 and 26 respectively. In this instance, both of the contact angles θ1 and θ2 are the right angle (or 90°). Under this condition, the liquid optical element 20 permits the incident beam impinging thereon to pass through and emerges as such from the interface IF without undergoing optical actions such as convergence, dispersion, and deflection at the interface IF.

In the case where the potential V1 differs from the potential V2 (V1≠V2), the interface IF becomes a flat plane which inclines relative to the X-axis and Z-axis (but is parallel to the Y-axis), so that θ1≠θ2, as shown in FIGS. 7B and 7C. To be more specific, in the case where the potential V1 is larger than the potential V2 (or V1>V2), the contact angle θ1 is larger than the contact angle θ2 (or θ1>θ2), as shown in FIG. 7B. Conversely, in the case where the potential V1 is smaller than the potential V2 (or V1<V2), the contact angle θ2 is larger than the contact angle θ1 (or θ1<θ2), as shown in FIG. 7C. In this case (where V1≠V2), the liquid optical element 20 permits the incident light impinging thereon parallel to the first and second electrodes 25 and 26 to undergo refraction and deflection in the XZ plane at the interface IF. It follows, therefore, that the incident light can be deflected to any direction in the XZ plane according as the potentials V1 and V2 are properly adjusted in magnitude.

The foregoing phenomenon that the contact angles θ1 and θ2 change depending on the voltage applied takes place by the mechanism which is assumed as follows. The voltage application accumulates charges on the inner surfaces 28A and 28B, and the accumulated charges exert a Coulomb force which attracts the polar liquid 29P having polarity toward the insulating film 28. As the result, the polar liquid 29P increases the area in contact with the inner surfaces 28A and 28B and also moves (or deforms) to exclude the apolar liquid 29N from that part with which the apolar liquid 29N is in contact. These actions result in the interface IF becoming a flat plane.

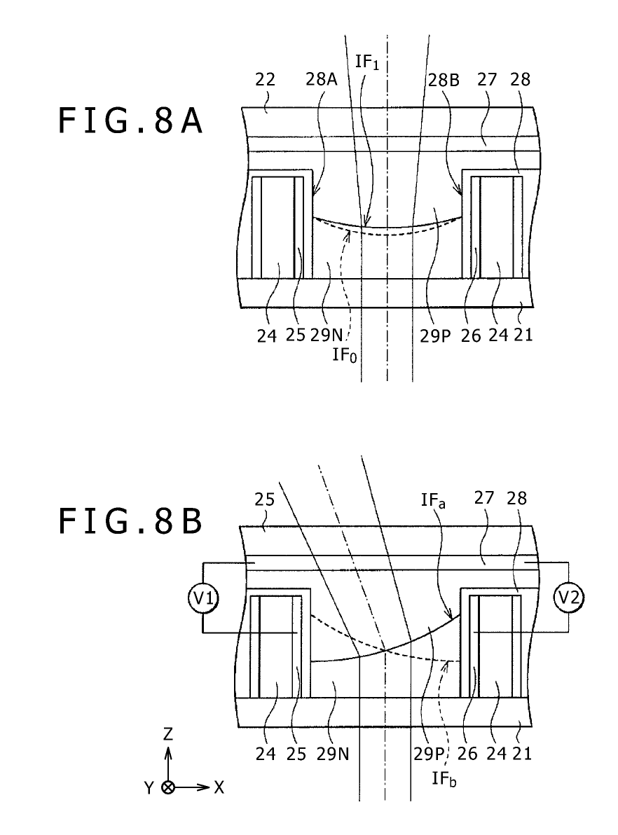

Moreover, the liquid optical element 20 is designed such that the interface IF changes in curvature depending on the magnitudes of potentials V1 and V2. For example, if it is assumed that the potentials V1 and V2 (in equal magnitudes) are lower than the potential Vmax which makes the interface IF a flat plane, then the potentials V1 and V2 create the interface IF₁ (indicated by a solid line) which has a smaller curvature than the interface IF₀ (indicated by a broken line) which is created when the potentials V1 and V2 are null, as shown in FIG. 8A. Thus, the refraction which the light passing through the interface IF undergoes varies depending on the magnitudes of the potentials V1 and V2 which are properly adjusted. In other words, the liquid optical element 20 functions as a varifocal lens. Moreover, if the potentials V1 and V2 are so adjusted as to take on mutually different magnitudes (or V1≠V2), the interface IF inclines while keeping its adequate curvature. For example, in the case that V1 is larger than V2 (V1>V2), the interface IFa is created as indicated by a solid line in FIG. 8B. Likewise, in the case of V1<V2, the interface IFb is created as indicated by a broken line in FIG. 8B. Consequently, the liquid optical element 20 is able to deflect the incident light in a desired direction while adequately refracting the incident light if the potentials V1 and V2 are properly adjusted. Incidentally, FIGS. 8A and 8B represent an instance in which it is assumed that the apolar liquid 29N has a larger refractive index than the polar liquid 29P and the liquid optical element 20 exhibits the negative refractive force so that the incident light changes in its direction when the interfaces IF₁ and IFa are formed.

### <Preparation of the Wave Surface Conversion Deflector>

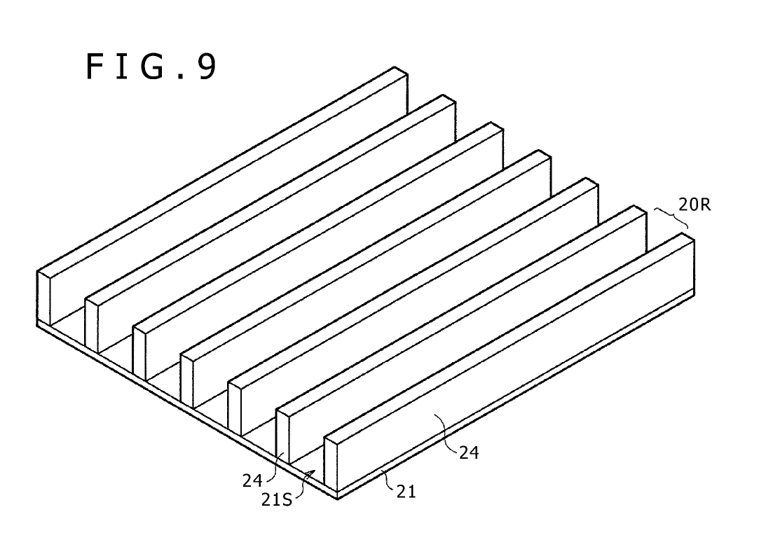

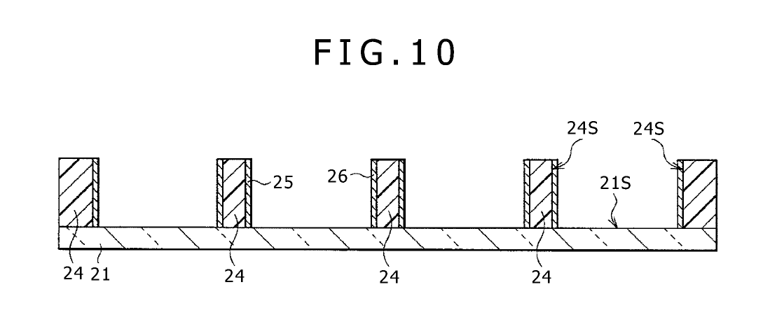

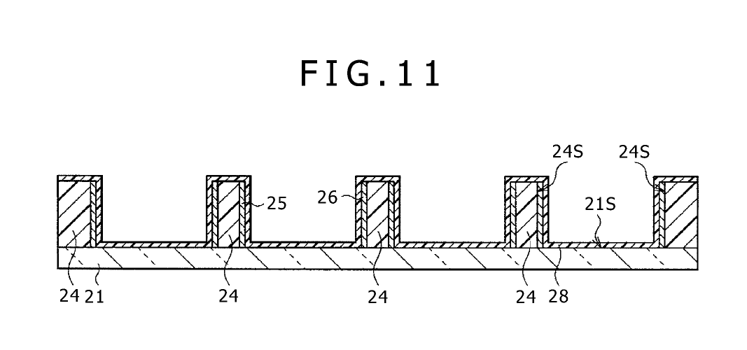

The following is a description of the process for preparation of the wave surface conversion deflector 2 with reference to a perspective view shown in FIG. 9 and schematic sectional views shown in FIGS. 10 and 11 (taken along the XY-plane).

The process starts with forming the partition walls 24 at specific positions on the front surface 21S of the flat substrate 21 made of a specific material, as shown in FIG. 9. As the result of this first step, there are formed a plurality of the element region 20R separated by the partition walls 24. To be concrete, this first step is accomplished by photolithography or molding. The former consists of uniformly coating the inner surface 21S with a specific plastic resin by spin coating or the like and ensuing selective exposure for patterning. The latter permits the flat substrate 21 and the partition walls 24 to be formed integrally from a single material with the help of a mold of specific design. The molding includes injection molding, thermal press molding, film transfer molding, and 2P-process (photoreplication process).

Subsequently, the intermediate product obtained in the first step undergoes laser beam processing (preferably with CO₂ laser) to make each of the first and second through-holes 21H1 and 21H2 at specific positions in each of the element region 20R separated by the partition walls 24.

The first and second through-holes 21H1 and 21H2, which have been formed as mentioned above, have their inner wall coated or have their inside filled so that the first and second connecting parts 21T1 and 21T2 are formed. To be concrete, this step is accomplished by screen printing, letterpress printing, or offset printing. According to this embodiment, the foregoing object is achieved by coating the inner surface (or by filling the inside) of the first and second through-holes 21H1 and 21H2 with an electrically conductive paste containing silver (Ag), which is applied from the outer surface 21SS, or achieved by filling inside the first and second through-holes 21H1 and 21H2 with the electrically conductive paste. The electrically conductive paste is an Ag paste (preferably Ag nano-paste) or carbon paste of heat-curing type or UV-curing type, having a viscosity higher than 10000 cP. After coating on or filling in the first and second through-holes 21H1 and 21H2, the electrically conductive paste is liable to flow and spread to the vicinity of the openings of the through-holes 21H1 and 21H2, reaching the adjoining element region 20R. However, this does not occur and actually prevented by existence of the partition walls 24. Therefore, there is no possibility of short-circuiting between the adjoining first electrodes 25 or the adjoining second electrodes 26.

In the next step, the partition wall 24 has its surfaces 24S covered with the first and second electrodes 25 and 26 by direct current sputtering, as shown in FIG. 10. The first and second electrodes 25 and 26 in the effective region 20Z1 are formed such that they face each other. By contrast, in the connecting region 20Z2, only the first electrode 25 is formed by using a metal mask. Likewise, in the connecting region 20Z3, only the second electrode 26 is formed by using a metal mask. The result is that electrical conduction takes place between the first connecting part 21T1 and the first electrode 25 and between the second connecting part 21T2 and the second electrode 26. In addition, the flat substrate 21 has its outer surface 21SS processed to form the first and second lead wires 31 and 32 at predetermined positions. This process is accomplished by spin coating (to apply a resist), patterning (to form a resist mask having a predetermined form), plating or sputtering (to form a metal film), and lifting off the mask.

Subsequently, the substrate 21 and the partition walls 24 are entirely covered with the insulating film 28 by vacuum deposition or the like, as shown in FIG. 11. Then, the space separated by the partition walls 24 is partly filled with the apolar liquid 29N by injection or dropping. The resulting assembly is lidded with the flat substrate 22 provided with the third electrode 27 in such a way that the flat substrate 21 and the flat substrate 22 face each other, with a certain gap left between them. The two flat substrates 21 and 22 are joined together with the side wall 23 and the adhesive layer AL attached thereto. The adhesive layer AL is formed (with a small hole left open therein as an inlet) along the overlapping periphery of the two flat substrates 21 and 22. The space surrounded by the flat substrate 21, the side walls 23, the partition walls 24, and the flat substrate 22 is filled with the polar liquid 29P through the inlet. The inlet is finally closed. The foregoing simple procedure gives the wave surface conversion deflector 2 which is provided with a plurality of the liquid optical element 20 excelling in responsiveness.

### <Action of the Stereoscopic Display Apparatus>

The stereoscopic display apparatus according to the present disclosure works in the following way as shown in FIG. 1. Upon reception of video signals by the display unit 1, the display pixel 12L emits the display image light I-L for the left eye and the display pixel 12R emits the display image light I-R for the right eye. Both of the display image light I-L and the display image light I-R impinge on the liquid optical element 20. At the same time, the first and second electrodes 25 and 26 of the liquid display element 20 are given a voltage of adequate value so that the focal length is equal to the distance calculated from the refractive index in air between the display pixels 12L or 12R and the interface IF. Alternatively, the focal length of the liquid optical element 20 may be adjusted according to the viewer's position. The display image lights I-L and I-R respectively emerging from the display pixels 12L and 12R of the display unit 1 have their emerging angle varied by the cylindrical lens formed by the interface IF between the apolar liquid 29N and the polar liquid 29P in the liquid optical element 20. As the result, the display image light I-L impinges on the viewer's left eye 10L and the display image light I-R impinges on the viewer's right eye 10R, as shown in FIG. 1. In this way the viewer can watch a stereoscopic image.

Alternatively, the liquid optical element 20 may function while keeping the interface IF flat as shown in FIG. 7A. In this case the wave surface conversion is not performed on the display image lights I-L and I-R, and this realizes a high-definition stereoscopic image display.

### <Effect of the Stereoscopic Display Apparatus>

According to the embodiment mentioned above, the wave surface conversion deflector 2 is constructed such that the flat substrate 21 has the first and second through-holes 21H1 and 21H2 formed therein and the first and second through-holes 21H1 and 21H2 have their inner surface coated so that the first and second connecting parts 21T1 and 21T2 are formed. The first and second electrodes 25 and 26 are connected to the first and second lead wires 31 and 32 formed on the opposite surface (outer surface 21SS) through the first and second connecting parts 21T1 and 21T2. This structure permits the first and second lead wires 31 and 32 to have a sufficient width and a sufficient interval for their arrangement without the necessity of expanding the area for the wave surface conversion deflector 2. Moreover, the fact that the first and second through-holes 21H1 and 21H2 are positioned in the element region 20R held between the adjacent paired partition walls 24 eliminates short-circuits (due to manufacturing errors) between the first and second electrodes 25 and 26 which adjoin each other with the partition wall 24 held between them. This makes it possible to perform the connection of the first and second lead wires 31 and 32 with the first and second electrodes 25 and 26, and the insulation of the first and second electrodes 25 and 26 from each other, securely and comparatively easily. Consequently, the stereoscopic display apparatus is capable of controlling the potentials for the first and second electrodes 25 and 26 independently, and also capable of performing the wave surface conversion and deflection accurately on the display image light emitted from the display unit 1. In conclusion, the stereoscopic display apparatus according to the present disclosure provides accurate stereoscopic images in response to predetermined video signals despite its compact structure.

### [Examples of Application of the Stereoscopic Display Apparatus]

### <Electronic Device>

The stereoscopic display apparatus mentioned above will find various uses as exemplified below.

The display apparatus according to the present disclosure can be applied to various kinds of electronic devices without specific restrictions. It may be mounted on any of the electronic devices which are listed below only for the sake of exemplification. It may be properly modified in structure according to its application.

One example of applications is a television set shown in FIG. 12. This television set is provided with the video display screen 200 as the display apparatus, which includes the front panel 210 and the filter glass 220.

The display apparatus according to the present disclosure may also be applied to tablet-type personal computers (PC), note-type PCs, mobile phones, digital still cameras, video cameras, and video display units on car navigation systems, in addition to the television set shown in FIG. 12.

Although the present disclosure has been described above with reference to some examples, it may be variously changed and modified without being restricted in its scope to them. For example, the foregoing example which is designed such that the liquid optical element 20 of the wave surface conversion deflector 2 performs both converging (or dispersing) action and deflecting action, may be modified such that the wave surface converting part and the deflecting part are provided separately so that the converging (or dispersing) action and the deflecting action are accomplished by separate devices.

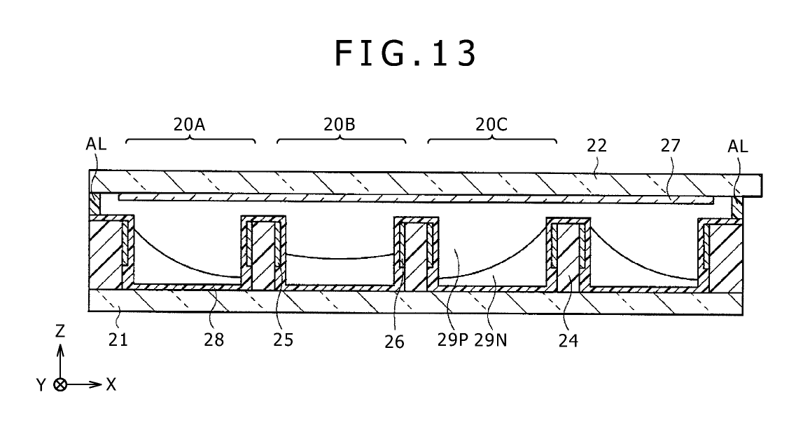

In addition, as shown in FIG. 13, a plurality of liquid optical elements 20 can be combined to work as a single cylindrical lens corresponding to a set of the display pixels 12L and 12R. Incidentally, in FIG. 13, an example to configure one cylindrical lens by three liquid optical elements 20A, 20B, and 20C is shown.

The embodiment mentioned above, in which the surface 24S of the partition wall 24 is perpendicular to the surface 21S of the flat substrate 21, may be modified such that the surface 24S of the partition wall 24 is inclined toward the surface 21S of the flat substrate 21.

The foregoing embodiment illustrates a color liquid-crystal display that employs a backlight as the means of generating two-dimensional images (display unit). However, the present disclosure may also be applied to a display with organic EL elements or a plasma display.

Moreover, the liquid optical element and wiring substrate according to the present disclosure may be applied to not only the stereo display apparatus but also various devices that need optical actions.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims

The invention is claimed as follows:

1. An optical element comprising:
a first substrate and a second substrate arranged opposite to each other;
a plurality of partition walls which rise from an inner surface of said first substrate, which faces said second substrate, and which also adjoin to one another in a first direction, and extend in a second direction differing from said first direction;
a first through-hole and a second through-hole which are formed in a region held between the adjoining paired partition walls on said first substrate;
a first electrode and a second electrode which are formed on the surface of said partition walls in such a way that said first electrode and said second electrode partly face each other;
an insulating film covering said first and second electrodes;
a third electrode formed on an inner surface of second substrate, which faces said first substrate; and
a polar liquid and an apolar liquid, both having mutually different refractive indices, which are enclosed between said first substrate and said third electrode,
wherein said first electrode is connected through said first through-hole to a first lead wire formed on an outer surface of said first substrate which is opposite to the inner surface, and
said second electrode is connected through said second through-hole to a second lead wire formed on the outer surface of said first substrate.

2. The optical element as defined in claim 1, wherein said first and second through-holes are so formed as to have a larger opening area on the outer surface of said first substrate than on the inner surface of said first substrate.

3. The optical element as defined in claim 2, wherein said first and second through-holes are formed in such a way that each opening area increases in going from the inner surface to the outer surface of said first substrate.

4. The optical element as defined in claim 1, wherein
the connection between said first electrode and said first lead wire is established by a first connecting part which covers the inner surface of said first through-hole or fills the inside of said first through-hole, and
the connection between said second electrode and said second lead wire is established by a second connecting part which covers the inner surface of said second through-hole or fills the inside of said second through-hole.

5. The optical element as defined in claim 4, wherein said first and second lead wires extend in a third direction different from said second direction.

6. The optical element as defined in claim 5, wherein:
said first and second electrodes, said first and second connecting parts, and said first and second lead wires are formed in a plural number;
said first connecting parts are periodically and individually connected to said first lead wires; and
said second connecting parts being periodically and individually connected to said second lead wires.

7. The optical element as defined in claim 1, wherein:
only said first electrode out of said first and second electrodes is formed on corresponding one of side surfaces of said partition walls which hold a region in which said first through-hole is formed therebetween; and
only said second electrode out of said first and second electrodes is formed on corresponding one of side surfaces of said partition walls which hold a region in which said second through-hole is formed therebetween.

8. A display apparatus comprising
a display unit; and
an optical element,
said optical element including
a first substrate and a second substrate which are arranged opposite to each other,
a plurality of partition walls which rise from an inner surface of said first substrate, which faces said second substrate, and which also adjoin to one another in a first direction, and extend in a second direction differing from said first direction,
a first through-hole and a second through-hole which are formed in a region held between the adjoining paired partition walls on said first substrate,
a first electrode and a second electrode which are formed on respective side surfaces of said partition walls in such a way that said first and second electrodes partly face each other, and
an insulating film covering said first and second electrodes,
a third electrode which is formed on an inner surface of second substrate, which faces said first substrate, and
a polar liquid and an apolar liquid, both having mutually different refractive indices, which are enclosed between said first substrate and said third electrode, wherein
said first electrode is connected through said first through-hole to a first lead wire formed on an outer surface of said first substrate which is opposite to the inner surface, and
said second electrode is connected through said second through-hole to a second lead wire formed on the outer surface of said first substrate.

9. An electronic device comprising:
a display apparatus having a display unit and an optical element,
said optical element including
a first substrate and a second substrate which are arranged opposite to each other,
a plurality of partition walls which rise from the inner surface of said first substrate, which faces said second substrate, and which also adjoin to one another in a first direction and extend in a second direction differing from said first direction,
a first through-hole and a second through-hole which are formed in a region held between the adjoining paired partition walls on said first substrate,
a first electrode and a second electrode which are formed on the surface of said partition walls in such a way that said first and second electrodes partly face each other,
an insulating film covering said first and second electrodes,
a third electrode which is formed on an inner surface of second substrate, which faces said first substrate, and
a polar liquid and an apolar liquid, both having mutually different refractive indices, which are enclosed between said first substrate and said third electrode,
wherein said first electrode is connected through said first through-hole to a first lead wire formed on an outer surface of said first substrate which is opposite to the inner surface, and
said second electrode is connected through said second through-hole to a second lead wire formed on the outer surface of said first substrate.

10. A wiring substrate comprising:
a plastic resin substrate;
a plurality of partition walls rising on one surface of said plastic resin substrate;
a through-hole formed in said plastic resin substrate in the region held between a pair of said partition walls facing each other;
a pair of electrically conductive films formed on both surfaces of said plastic resin substrate; and
a connecting part for the connection of said paired electrically conductive films through said through-hole.

11. The wiring substrate as defined in claim 10, wherein said through-holes are so formed as to have a larger opening area on the other surface of said plastic resin substrate than on said one surface of said plastic resin substrate.

12. The wiring substrate as defined in claim 10, wherein said connecting part covers the inner surface of said through-hole or fills the inside of said through-hole.
